(19) United States
(12) Patent Application Publication
(10) Pub. No.: US 2009/0258221 A1
(43) Pub. Date: Oct. 15, 2009

(54) Light-Reflective Articles and Methods for Making Same

(75) Inventors: David A. Diehl, Pittsburgh, PA (US); Nicholas J. Mullins, Raleigh, NC (US); Max L. Howells, Palm Coast, FL (US); Jeanne D. Housman, Chestnut Hill, MA (US)

Correspondence Address: JAY M BROWN, 6409 FAYETTEVILLE RD. SUITE 120-306, DURHAM, NC, 27713, US

(73) Assignee: VTEC TECHNOLOGIES, LLC, Southfield, MI (US)

(21) Appl. No.: 12/102,959

(22) Filed: Apr. 15, 2008

(51) Int. Cl. B32B 27/00; B32B 9/00

(52) U.S. Cl. 428/332; 428/704; 428/446; 428/447

(57) ABSTRACT

Light-reflective article including polymeric substrate; tie layer disposed on polymeric substrate and having composition including metal element; support layer including diamond-like carbon disposed on tie layer; and light-reflective layer disposed on support layer and having composition including metal element. Light-reflective article further including lubricious, optically-transparent protective layer disposed on light-reflective layer and including diamond-like carbon, silicon, and oxygen. Method for fabricating article.

### BACKGROUND

1. Field of the Invention

This invention generally relates to light-reflective articles having a system of layers, including a light-reflective layer, on a polymeric substrate.

2. Related Art

Various types of multi-layer, light-reflective articles have been developed for use as mirrors, optical lenses, and in other products for which a reflective, shiny or chromed appearance is functionally or aesthetically useful. Such articles typically include a system of layers or coatings, including a light-reflective component, formed on a glass, metal or ceramic substrate. In some cases, substrates having an organic polymer composition have been employed. There is an increasing interest in the fabrication of polymer-based articles to realize one or more advantages commonly attributed to various polymers. As examples, such advantages may include wide availability of starting materials, low production cost, well-known production techniques, ability to form complex shapes, light weight, and a wide variety of specifiable properties such as structural flexibility, hardness, environmental durability, etc. For these and other reasons, articles including coated polymeric substrates may be useful replacements for articles having coated glass substrates.

Accordingly, there is a continuing need for light-reflective articles based on polymeric substrates, particularly light-reflective articles exhibiting excellent hardness, abrasion resistance, and/or other performance criteria such as described below.

### SUMMARY

According to one implementation, a light-reflective article is provided that includes a polymeric substrate; a tie layer disposed on the polymeric substrate and having a composition including a metal element; a support layer including diamond-like carbon disposed on the tie layer; and a light-reflective layer disposed on the support layer and having a composition including a metal element. In an example, such an article may further include a lubricious, optically-transparent protective layer disposed on the light-reflective layer, the protective layer including diamond-like carbon, silicon, and oxygen. As another example, the light-reflective article may include a polymeric coating layer disposed on the polymeric substrate, wherein the tie layer is disposed on the polymeric coating layer.

According to another implementation, a method is provided for fabricating a light-reflective article. The method includes depositing a tie layer on a polymeric substrate, the deposited tie layer having a composition including a metal element; depositing a support layer including diamond-like carbon on the tie layer; and depositing a light-reflective layer on the support layer, the light-reflective layer having a composition including a metal element. As an example, the method may further include depositing a protective layer on the light-reflective layer, the deposited protective layer being lubricious and optically-transparent and including diamond-like carbon, silicon, and oxygen. As another example, the method may include, prior to depositing the tie layer, depositing a polymeric coating layer on the polymeric substrate.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a cross-sectional elevation view illustrating an example of a light-reflective article according to one implementation.

FIG. 2 is a cross-sectional elevation view illustrating an example of a light-reflective article according to another implementation.

FIG. 3 is a flow diagram illustrating an example of a method for fabricating a light-reflective article according to one implementation.

### DETAILED DESCRIPTION

Various coating systems have been applied to polymeric substrates to protect the finished articles and/or to add light-reflective properties to the finished articles. Depending on the nature of the finished article, for example an automotive mirror or a decorative component, the resulting coated article may be required to meet various specifications or performance standards to be considered acceptable for commercial or industrial applications, one example being the automotive industry. Light-reflective articles have conventionally been fabricated on substrates by solution-based electroplating. Electroplated articles often meet required performance criteria but are attended by significant environmental and health-related problems. Electroplating typically entails the use of toxic solutions that include heavy metal-containing compounds such as lead compounds and hexavalent chromium compounds. Lead is recognized as a neurotoxin and hexavalent chromium is recognized as a human carcinogen via inhalation. Such toxic solutions are therefore a serious hazard to the health of manufacturing personnel and pose a significant environmental hazard. Restrictions on the utilization of solution-based electroplating in manufacturing processes continue to expand, and solution-based electroplating may ultimately be banned completely.

As an alternative to electroplating, the properties of articles based on polymer substrates may be improved by coating the polymer substrate with a dielectric material such as glass or silicon dioxide, for example using a vacuum deposition process. However, the adhesion of such coatings to polymer substrates has generally been poor, resulting in failure modes such as cracking and delamination. Additionally, properties such as abrasion resistance and hardness of these coated articles are still considered unacceptable for many applications. Coating systems applied to polymeric substrates by vacuum deposition, as an example, for protective and light-reflective purposes, have not resulted in articles that meet the all of the various specifications or performance standards required by many industries. Well-known problems attending polymeric substrates coated with vacuum-deposited materials, as an example, have included poor exterior durability, poor reliability, poor production consistency, and poor structural integrity. Specific problems have included poor adhesion of protective and light-reflective layers to polymeric substrates, susceptibility of polymer-based articles to abrasion and scratching, low hardness, and substandard performance in thermal cycling, moisture cycling, salt-spray corrosion resistance cycling, and other environmental or durability testing. For example, polymer-based light-reflective articles coated with vacuum-deposited materials have failed to approach the performance specifications of the glass-based light-reflective articles that polymer-based light-reflective articles are intended to replace, one example being automotive mirrors.

Various forms of diamond-like carbon (DLC) have properties of good hardness, scratch resistance and environmental durability. DLC films have been deposited as outer protective coatings primarily on magnetic hard drives and metal articles such as automotive engine components. In some cases, DLC films have been deposited on glass and plastic substrates to serve as outer protective coatings. Unfortunately, DLC may adhere poorly to plastic substrates due to the high level of internal stress that may develop in DLC during deposition and the difference in coefficients of thermal expansion (CTE) between DLC and polymers. Upon cool-down after deposition, DLC typically cracks and/or delaminates from the underlying substrate. Consequently DLC-coated substrates, for example in cases where the DLC is deposited directly on plastic substrates, have not yielded commercially-acceptable or industry-acceptable products.

DLC as an outer protective layer is often required to be optically-transparent. Accordingly, outer protective coatings including DLC have generally been quite thin (e.g., about 100 Å or less) because thicker DLC films exhibit significant color and thus absorb substantial light. Thin DLC films may not be able to full advantage of properties such as hardness and scratch resistance of which many compositions including DLC would be capable if the DLC was made thicker.

For purposes of the present disclosure, it will be understood that when a layer (or film, region, substrate, component, device, or the like) is referred to as being “on” or “over” another layer, that layer may be directly or actually on (or over) the other layer or, alternatively, intervening layers (e.g., buffer layers, transition layers, interlayers, sacrificial layers, etch-stop layers, masks, electrodes, interconnects, contacts, or the like) may also be present. When a layer is stated as being “directly on” another layer, no intervening layer is present unless otherwise indicated. It will also be understood that when a layer is referred to as being “on” (or “over”) another layer, that layer may cover the entire surface of the other layer or only a portion of the other layer. It will be further understood that terms such as “formed on” or “disposed on” are not intended to introduce any limitations relating to specific methods of material transport, deposition, fabrication, surface treatment, or physical, chemical, or ionic bonding or interaction.

Unless otherwise indicated, no limitation is placed on the stoichiometries of any compounds or compositions referred to herein.

As used herein, the term “diamond-like carbon” or “DLC” generally encompasses various forms of amorphous carbon-containing compositions having a significant concentration of tetrahedral sp³ carbon-carbon (C—C) atomic bonds. DLC encompasses, as examples, those diamond-like carbon compositions known as ta-C, ta-C:H, DLCH, PLCH, and GLCH. See, e.g., Casiraghi et al., “Diamond-like carbon for data and beer storage,” Materials Today, Vol. 10, No. 1-2, pp. 44-53 (Elsevier Ltd. 2007), the entire content of which is incorporated by reference herein. Generally, the concentration of diamond-like tetrahedral sp³ C—C bonding in DLC is higher than a concentration of graphitic trigonal sp² C—C bonding. A ta-C (tetrahedral amorphous carbon) composition has a highly tetrahedral C—C bond morphology, does not contain hydrogen, and has a C—C sp³ atomic bond concentration of more than 60%. It is understood throughout this specification that a stated percentage concentration of C—C atomic bonding in an example of DLC is defined as a molar proportion of a given type of C—C atomic bonds relative to a molar total of all C—C atomic bonds in the example of DLC. For example, where a sample of DLC is stated to contain 60% tetrahedral sp³ C—C atomic bonds, then 60% of all C—C atomic bonds in the sample of DLC are in the tetrahedral sp³ form. A ta-C composition having a C—C sp³ atomic bond concentration of more than about 90% may be utilized, provided that resulting surface stresses are not great enough to impair structural integrity. A ta-C:H (hydrogenated ta-C) composition includes 25-35 atomic % hydrogen and an sp³ C—C atomic bond concentration up to 70%. Throughout this specification it is understood that “atomic %” means that the indicated molar percentage of atoms in a subject composition are atoms of the indicated periodic element, such as carbon, hydrogen, oxygen, or silicon. For example, carbon dioxide contains 33.3 atomic % carbon and 66.6 atomic % oxygen. A DLCH (diamond-like a-C:H) composition includes 20-40 atomic % hydrogen and an sp³ C—C atomic bond concentration up to about 70%. A PLCH (polymer-like a-C:H) composition has more than 40 atomic % hydrogen and an sp³ C—C atomic bond concentration up to 70%. A GLCH (graphite-like a-C:H) composition includes less than 20 atomic % hydrogen and a concentration of less than 20 atomic % sp³ C—C atomic bonds. These diamond-like carbon compositions may also include one or more metal elements such as silicon, tungsten, titanium, mixtures of the foregoing, or other metal or non-metal elements. An sp³ C—C atomic bond concentration of a DLC sample may be quantitatively determined, for example, utilizing Raman spectra of the sample employing visible and ultra-violet wavelengths. See, e.g., Gilkes, K. W. R. et al., “Direct Quantitative Detection of the sp³ Bonding in Diamond-Like Carbon Films Using Ultra-violet and Visible Raman Spectroscopy,” Journal Applied Physics, Vol. 87, No. 10, pp. 7283-7289 (May 15, 2000), the entire content of which is incorporated by reference herein.

As used herein, the term “light-reflective” or “optically reflective” means that a given component (layer, film, or the like) reflects 40-100% of the visible light incident on that component as measured by SAE J964 (February 2003) and ASTM E429 (1991), the entireties of which standards are incorporated by reference herein.

As used throughout this specification, the term “optically-transparent” means that a given component (layer, film, or the like) transmits light reflected from a light-reflective component without appreciably altering the perceptual color of the light reflected from the light-reflective component. Such a given component of a light-reflective article is deemed to be “optically-transparent” if white light reflected from or through the component has a white perceptual color.

As used throughout this specification, the term “lubricious” means that a subject protective layer of a light-reflective article has a friction coefficient sufficiently small so that the protective layer adequately resists becoming scratched to an extent that would interfere with utilization of the light-reflective article in an intended end-use for an intended lifespan. In an example, the term “lubricious” as used throughout this specification may specifically mean that a subject protective layer of a light-reflective article has a friction coefficient of about 0.5 or less. As another example, the term “lubricious” as used throughout this specification may specifically mean that a subject protective layer of a light-reflective article has a friction coefficient of about 0.3 or less. For purposes of this specification, the friction coefficient of a protective layer of a light-reflective article is determined in accordance with ASTM Standard Test Method C-1028-89, the entirety of which is incorporated herein by reference. As used throughout this specification, the term “friction coefficient” denotes the unitless ratio of the frictional force between two bodies in contact, parallel to the surface of contact, to the force, normal to the surface of contact, with which the bodies press against each other.

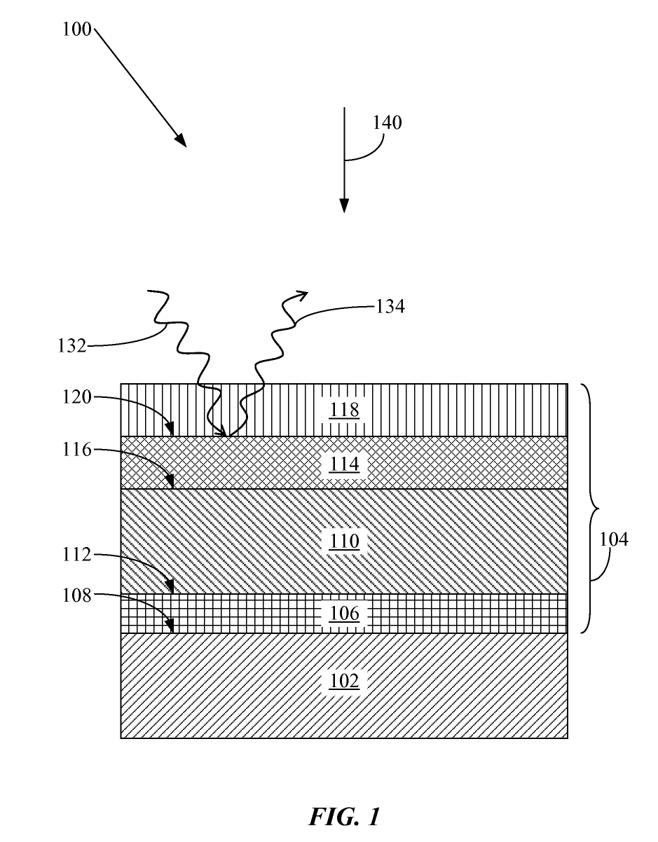

FIG. 1 is a cross-sectional elevation view of an example of a light-reflective article 100 according to one implementation. The light-reflective article 100 generally includes a polymeric substrate 102 on which is formed a protective, multi-layer or multi-component system 104 that includes a light-reflective component. Such a system is also referred to herein as a light-reflective coating system 104. The light-reflective coating system 104 may include a tie layer 106 disposed on an upper surface 108 of the polymeric substrate 102, a support layer 110 disposed on an upper surface 112 of the tie layer 106, a light-reflective layer 114 disposed on an upper surface 116 of the support layer 110, and an outer protective layer 118 disposed on an upper surface 120 of the light-reflective layer 114. Incident light traveling, for example, in a direction generally depicted by arrow 132 may be reflected by the light-reflective layer 114 and subsequently travel in a direction generally depicted by arrow 134. Thus, light may not be required to pass through the polymeric substrate 102 or other layers underlying the light-reflective layer 114. Accordingly, the light-reflective article 100 in the illustrated example may be characterized as a front-surface light-reflective article.

Viewed from the vertical direction of arrow 140, the light-reflective article 100 may have any selected shape and dimensions (e.g., round, circular, elliptical, rectilinear, polygonal, irregular, etc.). Moreover, with reference to a plane perpendicular to the arrow 140 and directed into or out from the drawing sheet of FIG. 1, the upper surface 120 of the light-reflective layer 114 may be flat and thus parallel to such a reference plane or alternatively may be contoured (e.g., concave or convex) relative to the reference plane. In the present context, it will be understood that the orientation of the light-reflective article 100 as depicted in FIG. 1 is arbitrary and thus terms such as “upper,” “lower,” “vertical,” and “horizontal” are merely descriptive of the illustrated example and are not limiting.

The polymeric substrate 102 may have a composition including any polymer, polymer blend, or polymer-containing composite. Examples of polymers include as examples, but are not limited to, polycarbonates (PC) such as allyl diglycol carbonate (CR-39®), polyacrylates such as polymethylmethacrylate (PMMA), polyvinyl chloride (PVC), polyethylene, polyamide, polyimide, acrylonitrile butadiene styrene (ABS), and nylon, as well as thermosets such as polyesters and epoxies, and blends or mixtures of the foregoing. The polymer may or may not be reinforced with fiberglass or another type of reinforcing structure. The polymeric substrate 102 may have any thickness and may itself be an article or device, or a part of an article or device, upon which the overlying light-reflective system 104 may be formed.

The tie layer 106 functions as an adhesion-promoting interlayer that improves the bonding of the support layer 110 to the underlying polymeric substrate 102. The tie layer 106 may include a material capable of strongly bonding to the underlying polymeric substrate 102 and to the overlying support layer 110 through implementation of a suitable deposition process such as a vacuum deposition technique (including appropriate cleaning and or other preparation of the upper surface 108 of the polymeric substrate 102). For example, the tie layer 106 may include a metal. For these purposes, the material of the tie layer 106 may include, as non-limiting examples, a metal such as chromium, titanium, aluminum, niobium, or the like, an alloy including two or more metals, or a metal compound which for example may be an oxide of a metal such as silicon or titanium (MOₓ), where M is a metal and x is a variable such as 2. Effective metals for utilization in a composition of the tie layer 106 may include chromium, titanium, and aluminum, as examples. Chromium, for example, has been found to provide an excellent adhesion promotion in a tie layer 106. As an example, the tie layer 106 may include a suitable dopant. The tie layer 106 may, for example, have a thickness in the direction of the arrow 140 of 10 Å or more. In another example, the tie layer 106 may have a thickness within a range of between about 10 Å and about 1,250 Å. In another example, the tie layer 106 may have a thickness within a range of between about 400 Å and about 1,000 Å. In another example, the tie layer 106 may have a thickness of about 750 Å. It is understood throughout this specification that all thicknesses of layers in a multi-layer light-reflective article such as the example 100 of a light-reflective article are defined in a direction transverse to a boundary of a layer, such as a thickness defined as parallel with the direction of the arrow 140. Insofar as the thickness of the tie layer 106 (as well as other layers) may not be precisely uniform over a given width or length of the light-reflective article 100 (e.g., a thickness parallel with the direction of the arrow 140 in FIG. 1), the term “thickness” as used herein may be considered as an average thickness of a layer over a given such width or length.

It will be noted for the example 100 of a front-surface reflecting implementation of a light-reflective article that light may not need to be transmitted through the polymeric substrate 102. Accordingly, the tie layer 106 may be, as examples, optically-transparent, translucent, or opaque, and thus may be colored or uncolored.

The tie layer 106 may be formed on the polymeric substrate 102 by any suitable process such as a vacuum deposition technique for example, including as examples, physical vapor deposition (PVD), chemical vapor deposition (CVD), thermal evaporation, and variants and hybrids of the foregoing. The deposition technique may also be a plasma-enhanced CVD (PECVD) technique in which a DC-, RF- or microwave-powered energetic plasma or corona discharge may be generated from a suitable inert background gas (e.g., helium, argon, krypton, neon, xenon, etc.), and/or by a focused ion beam, electron beam, or laser. The specific technique employed may depend on the selected composition of the tie layer 106. For example, the polymeric substrate 102 may be loaded in a vacuum deposition chamber along with a solid metal target. The metal target may be sputtered by a focused ion beam or an energetic plasma, or may be thermally evaporated or sublimated, and transported to the polymeric substrate 102 under the influence of a DC or AC, continuous or pulsed, voltage bias impressed between the metal target and a holder of the polymeric substrate 102. In another example, the metal species may be provided by dissociating a metal-containing precursor gas (e.g., an organometallic compound) in an energetic plasma. A plasma-enhanced technique, when implemented, may be assisted through the operation of a magnetron and/or inductive coupling device. As examples, the temperatures of the polymeric substrate 102 and the chamber interior during deposition of the tie layer 106 (as well as other layers) may vary according to the specific technique employed and composition of the polymeric substrate 102, provided that the temperature may be limited so as to not be high enough to degrade (e.g., melt, denature, depolymerize, etc.) the polymeric material of the polymeric substrate 102. Dopants, when included with the tie layer 106, may for example be sourced from a target including a metal, or from a suitable precursor gas flowed into the reaction chamber, depending on the specific dopant selected.

The support layer 110 may include a material that is capable of strongly bonding to the underlying polymeric substrate 102 (as facilitated by the tie layer 106) and to the overlying light-reflective layer 114 through any suitable deposition process such as a vacuum deposition technique, for example. In addition, the material of the support layer 110 may for example be a material that results in the support layer 110 having a significant hardness. In one example, the support layer 110 may have a hardness of 5H or more as measured by a pencil hardness test according to ASTM D 3363-92a and ECCA T4 (1984), the entireties of which standards are incorporated by reference herein. In other examples, the support layer 110 may have a hardness as high as 9H. Accordingly, in further examples, the support layer 110 may have a hardness of 6H, 7H, or 8H. The pencil hardness test may be performed, for example, by utilizing a Wolff-Wilborn pencil hardness tester available from Gardco (Paul N. Gardner Company, Inc., Pompano Beach, Fla.).

The support layer 110 may, for example, have a thickness of 200 Å or more. In another example, the support layer 110 may have a thickness within a range of between about 200 Å and about 10,000 Å. In another example, the support layer 110 may have a thickness within a range of between about 500 Å and about 5,000 Å. As a further example, the support layer 110 may have a thickness within a range of between about 800 Å and about 3,600 Å.

As in the case of the tie layer 106, the support layer 110 underlies the light-reflective layer 114 and thus in front-surface reflective implementations of light-reflective articles 100 may be colored or uncolored. In examples, the thickness of the support layer 110 that results in adequate hardness may be such that the support layer 110 exhibits visible color. For instance, in one example a DLC support layer 110 of 4,800 Å thickness has a gold color, and in another example a DLC support layer 110 of 1,600 Å thickness has a magenta color.

In some implementations, the support layer 110 may include DLC. The DLC may for example have an atomic carbon concentration of about 50% or more, and an atomic hydrogen concentration within a range of between about 5% and about 30%. In another example, the DLC may have an atomic carbon concentration of about 75% or more, and an atomic hydrogen concentration within a range of between about 5% and about 20%. In another example, the DLC may have an atomic carbon concentration within a range of between about 75% and about 90%, and an atomic hydrogen concentration within a range of between about 5% and about 20%. The DLC may for example have an sp³ C—C atomic bond concentration of about 60% or more. In another example, the sp³ C—C atomic bond concentration may be 75% or more. In other examples, the sp³ C—C atomic bond concentration may be within a range of between about 60% and about 90%, or within a range of between about 75% and about 90%. The DLC may have an average density within a range of between about 2.1 grams per cubic centimeter (“gm/cm³”) and about 3.5 gm/cm³. In another example, the DLC may have an average density within a range of between about 2.3 gm/cm³ and about 3.0 gm/cm³. The DLC may include one or more intentional dopants such as, for example, nitrogen, silicon, boron, fluorine, titanium, tungsten, or a combination including two or more of the foregoing, or other suitable dopants and combinations including such other suitable dopants. In still another example, the support layer 110 may have a carbon atomic concentration of about 75% or more, a hydrogen atomic concentration within a range of between about 5% and about 20%, and a silicon atomic concentration within a range of between about 2% and about 19%. One function of adding a dopant may be to decrease stress in the DLC during fabrication of the light-reflective article 100.

The DLC—containing support layer 110 may for example be formed on the tie layer 106 by any suitable process, such as the vacuum deposition technique mentioned above in conjunction with the tie layer 106. A suitable carbon-containing precursor gas such as a hydrocarbon (HC), may for example be provided in the reaction chamber. Examples of carbon-containing precursor gases may include, but are not limited to, methane (CH₄), ethylene (C₂H₄), acetylene (C₂H₂), n-butane (C₄H₁₀), benzene (C₆H₆), cyclohexane (C₆H₁₂), etc. The use of acetylene, for example, has been found to produce a high concentration of sp³ carbon-carbon (C—C) bonds in the DLC and greater hardness.

The light-reflective layer 114 includes a metal element suitable for providing a light-reflective upper surface 120, and which may be capable of strongly bonding to the underlying support layer 110 through any suitable process such as a vacuum deposition technique for example. Such a metal element may be present, as examples, in the form of a single metal, an alloy including a plurality of metals, or a metal composition including at least one metal element and which may include one or more other elements. In some implementations, the light-reflective upper surface 120 may be characterized as being optically smooth. The light-reflective layer 114 may for example have a thickness of 300 Å or more. In other examples, the light-reflective layer 114 may have a thickness within a range of between about 300 Å and about 5,000 Å. In other examples, the light-reflective layer 114 may have a thickness within a range of between about 600 Å and about 1,200 Å. Generally, in implementations of front-surface mirrors where an article 100 having a perceived color is not intended, the thickness of the light-reflective layer 114 may be great enough to mask the color (if any) exhibited by the underlying support layer 110. The composition of the light-reflective layer 114 may as examples include a metal such as but not limited to, chromium, aluminum, silver, nickel, rhodium, gold, platinum, palladium, alloys including two or more of the foregoing metal elements, and other compositions including at least one metal element. The light-reflective layer 114 may be deposited by any suitable process such as a vacuum deposition technique mentioned above.

The light-reflective layer 114 may have an average reflectance, for example, within a range of between about 40% and about 100% of visible light. As appreciated by persons skilled in the art, reflectance may be defined as the average fraction of incident solar energy within the visible wavelength range that is reflected by a surface such as the upper surface 120 of the light-reflective layer 114. Reflectance may be determined by utilizing spectrophotometric measurements at multiple wavelengths. The average reflectance may then be determined by an averaging process, using a standard solar spectrum over a selected visible wavelength range or of selected wavelengths in that range. The testing procedure disclosed in SAE J964 “Recommended Practice for Measuring Haze and Reflectance of Mirrors” (1998), the entirety of which is incorporated by reference into this specification, may be utilized. It is understood that certain end-use applications for light-reflective articles such as the example 100 of a light-reflective article may be useful for reflecting light partially or wholly outside the visible wavelength range. In such cases, a suitable wavelength range for operation of the light-reflective article 100 in such end-use applications may be substituted for the visible wavelength range and reflectance may be determined in an analogous manner.

The outer protective layer 118 may include a material that is capable of strongly bonding to the underlying light-reflective layer 114 through any suitable deposition process such as a vacuum deposition technique. In addition, the material of the outer protective layer 118 may be lubricious and optically-transparent at the thickness specified for this layer. The outer protective layer 118 may for example have a thickness of 10 Å or more. In another example, the outer protective layer 118 may have a thickness within a range of between about 10 Å and about 1,000 Å. Examples of compositions for the outer protective layer 118 may include, but are not limited to, optically-transparent CVD coatings. In some examples, the outer protective layer 118 may generally include carbon, hydrogen, silicon, and oxygen. In some implementations, the outer protective layer 118 may include DLC with silicon and oxygen added as dopants. The outer protective layer 118 may be deposited by any suitable process such as a vacuum deposition technique mentioned above. In one example, the outer protective layer 118 may be deposited by a CVD process in which an organosilicon precursor gas may first be flowed into a reaction chamber, followed by oxygen, and then followed by the organosilicon precursor gas again. A non-limiting example of a suitable organosilicon precursor gas is trimethylsilanol (trimethylhydroxysilane, or TMS).

In a further example, the outer protective layer 118 may have a composition including atomic carbon within a range of between about 15% and about 90%, and atomic hydrogen within a range of between about 20% and about 75%. In a still further example, the outer protective layer 118 may have a composition including atomic carbon within a range of between about 15% and about 90%, atomic hydrogen within a range of between about 20% and about 75%, atomic silicon within a range of between about 2% and about 19%, and atomic oxygen within a range of between about 2% and about 19%.

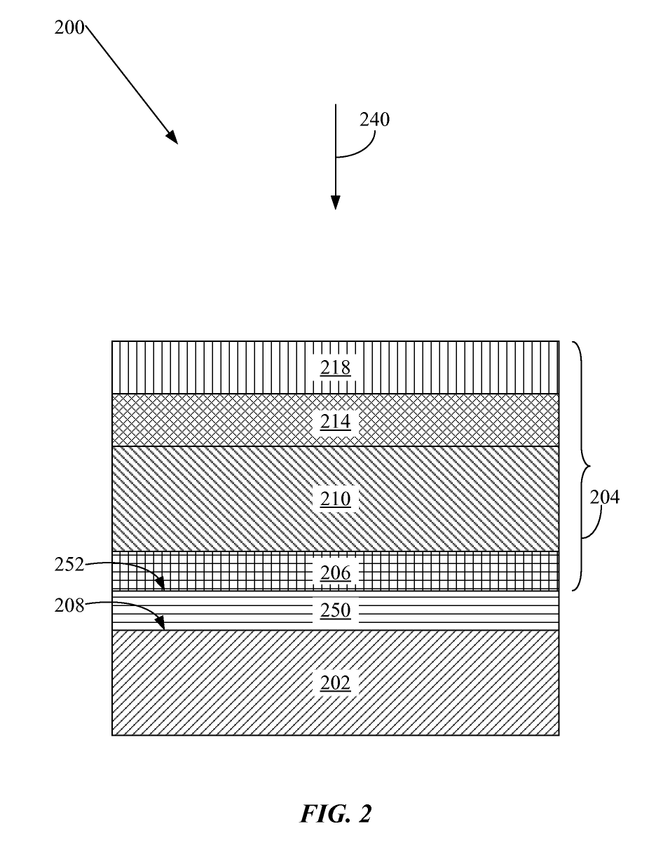

FIG. 2 is a cross-sectional elevation view of another example of a light-reflective article 200 according to one implementation. The light-reflective article 200 generally includes a polymeric substrate 202 on which is formed a light-reflective coating system 204. The light-reflective coating system 204 may for example include a tie layer 206, a support layer 210, a light-reflective layer 214, and an outer protective layer 218. The respective compositions, properties, thicknesses, other dimensions, and other aspects of the layers of the light-reflective article 200 may correspond to those described above in connection with the example 100 of a light reflective article illustrated in FIG. 1. By comparison, the light-reflective article 200 illustrated in FIG. 2 additionally may include a polymeric coating layer 250 applied to the upper surface 208 of the polymeric substrate 202. Accordingly, the tie layer 206 may for example be formed on an upper surface 252 of the polymeric coating layer 250. As examples, the composition of the polymeric coating layer 250 may include, but is not limited to, UV-curable multifunctional acrylates and polysiloxanes. The thickness of the polymeric coating layer 250 in a direction parallel with the arrow 240 may for example be within a range of between about 3 micrometers (“μm”) and about 5 μm. In other examples, the thickness of the polymeric coating layer 250 may range up to 1 mil (25.4 μm). In certain implementations, application of the polymeric coating layer 250 to the polymeric substrate 202 may be advantageous to provide a smoother morphology on which the light-reflective coating system 204 may be formed. The polymeric coating layer 250 may be applied by any suitable coating method. For example, in the case of an acrylate, the polymeric coating layer 250 may be applied by dip-coating, spray-coating, spin-on coating, flow-coating, curtain-coating, or the like. In examples, the polymeric coating layer 250 may then be UV-cured, and the resulting coated polymeric substrate 202 may thereafter be loaded into a vacuum deposition chamber for deposition of the tie layer 206, the support layer 210, the light-reflective layer 214, and the outer protective layer 218. In the case of a polysiloxane, the polymeric coating layer 250 may for example be applied by a vacuum deposition technique utilizing an organosilicon precursor gas such as, for example, hexamethyldisiloxane (HMDSO). Accordingly, a polysiloxane coating may be applied in the same vacuum deposition chamber as may be utilized for example to deposit the other layers of the light-reflective coating system 204.

In the fabrication of light-reflective articles such as the light-reflective articles 100 and 200 described by example above, a single reaction chamber and associated system may be configured to perform all of the various steps, which may as examples include vacuum deposition and surface treatment steps, required for depositing the multiple layers of the light-reflective coating system 104, 204 onto the polymeric substrate 102, 202. For instance, the same reaction chamber may include more than one type of target, more than one type of energetic source, more than one inlet or distribution hardware for different gases, and/or more than one distinct sub-chamber or deposition station. The polymeric substrate holder may be movable to different sub-chambers or deposition stations if such are provided. The same reaction chamber may be configured to generate wide-beam plasmas, narrow-beam plasmas, and/or ion beams or other energetic beams directed at or between different targets or sub-chambers and the polymeric substrate 102, 202. The associated deposition processing system may be configured for routing different background, precursor and reaction gases according to predetermined sequences, flow rates, flow ratios, etc. Generally, the reaction chamber and associated system may include devices for controlling various process parameters (e.g., electrical power, voltage bias, gas flow rates, polymeric substrate temperature, chamber pressure, etc.) specific to the deposition or surface preparation of each layer being formed on the polymeric substrate 102, 202. By such configuration, once the polymeric substrate 102, 202, coated or uncoated, has been prepared for fabrication of the light-reflective coating system 104, 204, the polymeric substrate 102, 202 may for example be loaded into such a reaction chamber. Once the reaction chamber has been purged and evacuated down to initial conditions, all deposition and surface preparation/modification steps may be carried out in the same reaction chamber without needing to break a vacuum. Thus, according to certain implementations, the entire light-reflective coating system 104, 204 may be fabricated on the polymeric substrate 102, 202 in a continuous in-situ process.

Surface treatment techniques that may be performed during fabrication of the light-reflective article 100, 200 may include techniques for cleaning a surface of a given layer in preparation for deposition of the next layer, as well as techniques for modifying the given layer to alter a property of the surface of the layer, a region of the layer that includes the exposed surface, or the entire layer. Examples of cleaning or surface preparation techniques include, but are not limited to, dry etching via ion beam bombardment, sputtering, or plasma exposure. Examples of surface modification techniques include, but are not limited to, doping by ion implantation and plasma-enhanced oxidation or nitridation. In one example, the surface of a polymeric layer may be oxidized to enhance chemical adhesion of the overlying tie layer 106, 206 or support layer 110, 210.

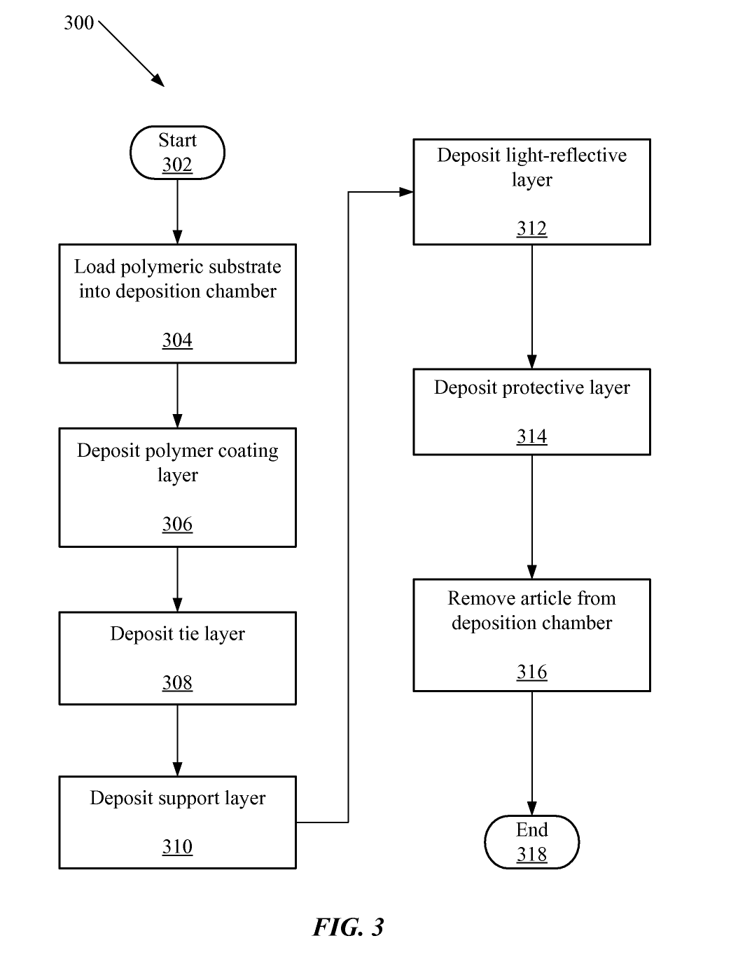

FIG. 3 is a flow diagram 300 illustrating an example of a method for controlling fabrication of a light-reflective article such as, for example, the light-reflective article 100 or 200 described by example above. This flow diagram 300 utilizes, as an example of a fabrication process, vapor deposition. It is understood throughout this specification by those skilled in the art, notwithstanding any statements made elsewhere in this specification, that vapor deposition techniques are merely examples and that other suitable techniques for fabricating light-reflective articles 100, 200 may be utilized alternatively or together with vapor deposition techniques. The flow diagram 300 may also represent an apparatus or system configured to perform the illustrated method. Such an apparatus or system may, for example, have attributes similar to those described elsewhere in the present disclosure. The method begins at the starting point 302. At block 304, a polymeric substrate is loaded into a vacuum deposition chamber. Prior to loading the polymeric substrate into the vacuum deposition chamber, the polymeric substrate may be cleaned or otherwise surface-prepared for undergoing the subsequent sequence of deposition steps. At block 306, for example, the polymeric substrate may additionally be coated with a polymeric coating layer, the polymeric coating layer may then be UV-cured, and the as-coated polymeric substrate may then be cleaned or otherwise surface-prepared. In another example, block 306 may be omitted. At block 308, a tie layer is deposited onto the polymeric substrate or on the polymeric coating layer if present, to a specified thickness. For example, the polymeric coating layer may include a polysiloxane. At block 310, a support layer is deposited onto the tie layer to a specified thickness. At block 312, a light-reflective layer is deposited onto the support layer to a specified thickness. At block 314, a protective layer may be deposited onto the light-reflective layer to a specified thickness. In another example, block 314 may be omitted. As noted above, one or more of the foregoing deposition steps may include cleaning or surface-modification steps that may be carried out without removing the article from the vacuum deposition chamber. After the protective layer has been deposited, for example, the article may be removed at block 316 from the vacuum deposition chamber, and the method may end at the ending point 318. It will be understood that a variety of post-deposition finishing processes may then be carried out as needed, depending on the nature or end-use of the article being fabricated.

The light-reflective articles taught in the present disclosure, including the examples 100, 200 described above, provide polymer-substrate based articles having advantageous features. The support layer 110, 210 may confer an advantageous hardness to the article 100, 200, for example light-reflective products, such that the relative softness of the polymeric substrate 102, 202 may not impair the performance of the article. A selected thickness and a selected hardness of the support layer 110, 210 may be made possible by the superior adherence of the support layer 110, 210 to the polymeric substrate 102, 202. As a result of the inclusion of this support layer 110, 210, in combination with the other layers of the light-reflective coating system 104, 204, the article 100, 200 may also exhibit excellent abrasion and scratch resistance.

### EXAMPLES

Light-reflective articles 100, 200 fabricated in accordance with implementations described above may be tested to determine whether such light-reflective articles 100, 200 meet various performance standards required by the automotive industry for articles that include coatings applied to glass substrates. Applicants believe that the light-reflective articles disclosed herein, including light-reflective articles 100, 200, will meet these performance standards, although none of the Examples included herein relating to testing of light-reflective articles have as yet been carried out. It is understood throughout this specification that the entireties of all testing-related and fabrication-related standards referred to anywhere in this specification are incorporated herein by reference. All compositions utilized in the light-reflective articles 200 discussed below may include appropriate material certifications such as lab accreditation or ISO certification, in accordance with Ford Motor Company's performance specification WSK-M4D775-A2, the entirety of which is incorporated herein by reference.

### Example 1

Light-reflective articles 200 fabricated in accordance with the implementation described above and illustrated in FIG. 2 may be subjected to temperature/humidity cycling and adhesion testing. Each light-reflective article 200 to be tested may include a polycarbonate/ABS polymeric substrate 202 formed as a bezel, a type of rim typically utilized in instrument clusters provided in automotive vehicles, the light-reflective article 200 further having an acrylate—containing polymeric coating layer 250 applied to the polymeric substrate 202, and a light-reflective coating system 204 applied to the polymeric coating layer 250. The light-reflective coating system 204 may include a chromium tie layer 206 adhered to the polymeric coating layer 250, a DLC support layer 210 on the tie layer 206, a chromium light-reflective layer 214 on the DLC support layer 210, and a DLC-containing TMS-metal oxide-TMS protective layer 218 on the light-reflective layer 214. Meeting the required performance criteria (i.e., passing the test) requires that the coating system 204 not be damaged by prolonged exposure to a temperature/humidity cycling environment followed by an adhesion test. The sample light-reflective articles 200 are examined visually for any defects prior to the start of testing. The sample light-reflective articles 200 are then placed in a 3 ft×3ft×3ft environmental chamber manufactured by Envirotronics, Grand Rapids, Mich. (Model No. SH27C). The environmental chamber is then repeatedly operated through a 48-hour controlled temperature and humidity cycle including 24 hours at 80° C. and ambient relative humidity; then 16 hours at 38° C. and 98% relative humidity; then 6 hours at −30° C. and ambient relative humidity; and then 2 hours at room temperature and ambient relative humidity. Each sample light-reflective article 200 is subjected to seven (7) of these 48-hour cycles, totaling 336 hours.

After the temperature/humidity cycling is completed, the sample light-reflective articles 200 are allowed to stabilize at room ambient temperature. At this time a visual inspection of the sample light-reflective articles 200 is made to determine whether any discoloration or visible loss of reflectivity of the sample light-reflective articles 200 has occurred compared with another sample light-reflective article 200 not subjected to the temperature and humidity cycling. Subsequently, an adhesion test is performed on each sample light-reflective article 200 by making a series of six (6) cuts into the sample light-reflective article 200 and then applying tape in a firmly secured manner over the cuts. The tape is then removed and a visual inspection is made to determine whether any of the coatings have been lifted from the respective sample light-reflective articles 200.

Passing this test protocol requires that no discoloration or visible loss of reflectivity is observed, nor any delamination or pinholes, as a result of the temperature/humidity cycling, and that the layers of the sample light-reflective articles 200 remain intact after the adhesion test. Applicants believe that light-reflective articles 200 will meet these performance standards, although this Example 1 has not yet been carried out.

### Example 2

Light-reflective articles 200 fabricated in accordance with the implementation described above and illustrated in FIG. 2 may be subjected to a paint oven repair test per Ford Motor Company's performance specification WSS-M98P13-A, Aug. 15, 2006, Section 3.4. Each light-reflective article 200 to be tested may be a first surface chrome (FSC) mirror including a polycarbonate polymeric substrate 202, an acrylate—containing polymeric coating layer 250 applied to the polymeric substrate 202, and a light-reflective coating system 204 applied to the acrylate—containing polymeric coating layer 250. The light-reflective coating system 204 may include a chromium tie layer 206 adhered to the acrylate—containing polymeric coating layer 250, a DLC support layer 210 on the tie layer 206, a chromium light-reflective layer 214 on the DLC support layer 210, and a DLC-containing TMS-oxide-TMS protective layer 218 on the light-reflective layer 214. Meeting the required performance criteria (i.e., passing the test) requires that the coating system 204 withstand a paint repair surface temperature of 115° C. for twenty (20) minutes with no deformation, functional damage, distortion, visual loss of reflectivity, or objectionable change in appearance of the reflective surface. The sample light-reflective articles 200 are placed in an environmental chamber manufactured by Envirotronics, Grand Rapids, Mich. (Model No. SHBC). The sample light-reflective articles 200 are exposed to the 115° C. environment in the environmental chamber for twenty (20) minutes. Meeting the required performance criteria further requires that no abnormalities be noted, and that review of the tested light-reflective articles 200 compared to untested control sample light-reflective articles 200 finds no deformation, functional damage, distortion, visual loss of reflectivity, or objectionable change in appearance of the reflective surface. Applicants believe that light-reflective articles 200 will meet these performance standards, although this Example 2 has not yet been carried out.

### Example 3

Light-reflective articles 200 fabricated in accordance with the implementation described above and illustrated in FIG. 2 may be subjected to a heat aging test per Ford Motor Company's performance specification WSS-M98P13-A, Aug. 15, 2006, Section 3.5. Each light-reflective article 200 to be tested may be a first surface chrome (FSC) mirror including a polycarbonate polymeric substrate 202, an acrylate—containing polymeric coating layer 250 applied to the polymeric substrate 202, and a light-reflective coating system 204 applied to the acrylate—containing polymeric coating layer 250. The light-reflective coating system 204 may include a chromium tie layer 206 adhered to the acrylate—containing polymeric coating layer 250, a DLC support layer 210 on the tie layer 206, a chromium light-reflective layer 214 on the DLC support layer 210, and a DLC-containing TMS-oxide-TMS protective layer 218 on the light-reflective layer 214. Meeting the required performance criteria (i.e., passing the test) requires that the coating system 204 after heat aging show no changes in appearance when compared with the original, untested sample light-reflective article 200. Gaps, margins and surface waviness must be within original design tolerances after returning to ambient temperature. The sample light-reflective articles 200 are placed in an environmental chamber manufactured by Envirotronics, Grand Rapids, Mich. (Model No. SHBC). The sample light-reflective articles 200 are exposed to a temperature of 80° C.±2° C. in the environmental chamber for seven (7) days (168 hours) and then conditioned back to 23° C.±2° C. Meeting the required performance criteria further requires that no abnormalities are noted when compared to the non-exposed control sample light-reflective articles 200; that the heat-exposed light-reflective articles 200 display no deformation, functional damage, distortion, visual loss of reflectivity, or objectionable change in appearance of the reflective surface; and that gaps, margins and surface waviness are within original design tolerances after returning to ambient temperature. Applicants believe that light-reflective articles 200 will meet these performance standards, although this Example 3 has not yet been carried out.

### Example 4

Light-reflective articles 200 fabricated in accordance with the implementation described above and illustrated in FIG. 2 may be subjected to an environmental test per Ford Motor Company's performance specification WSS-M98P13-A, Aug. 15, 2006, Section 3.6. Each light-reflective article 200 to be tested may be a first surface chrome (FSC) mirror including a polycarbonate polymeric substrate 202, an acrylate—containing polymeric coating layer 250 applied to the polymeric substrate 202, and a light-reflective coating system 204 applied to the acrylate—containing polymeric coating layer 250. The light-reflective coating system 204 may include a chromium tie layer 206 adhered to the acrylate—containing polymeric coating layer 250, a DLC support layer 210 on the tie layer 206, a chromium light-reflective layer 214 on the DLC support layer 210, and a DLC-containing TMS-oxide-TMS protective layer 218 on the light-reflective layer 214. Meeting the required performance criteria (i.e., passing the test) requires that the coating system 204 after environmental cycling show no changes in appearance when compared with the original, untested sample light-reflective article 200. Gaps, margins and surface waviness must be within original design tolerances after returning to ambient temperature. There should be no loss of adhesion between the reflective surface and the underlying polymeric substrate 202. The sample light-reflective articles 200 are placed in an environmental chamber manufactured by Envirotronics, Grand Rapids, Mich. (Model No. SHBC). The sample light-reflective articles 200 are exposed to three (3) cycles for a total exposure of seventy-two (72) hours. Each cycle includes the following conditioning intervals within the environmental chamber: three hours at 80° C., followed by one hour at 23° C. and 50% relative humidity (RH), followed by three hours at −40° C., followed by one hour at 23° C. and 50% RH, and followed by sixteen (16) hours at 38° C. and 95% RH. The sample light-reflective articles 200 are then evaluated after conditioning back to 23° C.±2° C. Following conditioning, the sample light-reflective articles 200 are subjected to adhesion testing per Ford Laboratory Test Method (FLTM) BI 106-01 B, the entirety of which is incorporated by reference herein. Meeting the required performance criteria further requires that no abnormalities are noted when compared to the non-exposed control samples; that the exposed light-reflective articles 200 display no deformation, functional damage, distortion, visual loss of reflectivity, or objectionable change in appearance of the reflective surface when compared to the untested sample light-reflective articles 200; and that following the adhesion test, the sample light-reflective articles 200 display no loss of adhesion of the reflective surface to the underlying polymeric substrate 202. Applicants believe that light-reflective articles 200 will meet these performance standards, although this Example 4 has not yet been carried out.

### Example 5

Light-reflective articles 200 fabricated in accordance with the implementation described above and illustrated in FIG. 2 may be subjected to an accelerated resistance to exterior weathering test per Ford Motor Company's performance specification WSS-M98P13-A, Aug. 15, 2006, Section 3.7.2. Each light-reflective article 200 to be tested may be a first surface chrome (FSC) mirror including a polycarbonate polymeric substrate 202, an acrylate—containing polymeric coating layer 250 applied to the polymeric substrate 202, and a light-reflective coating system 204 applied to the acrylate—containing polymeric coating layer 250. The light-reflective coating system 204 may include a chromium tie layer 206 adhered to the acrylate—containing polymeric coating layer 250, a DLC support layer 210 on the tie layer 206, a chromium light-reflective layer 214 on the DLC support layer 210, and a DLC-containing TMS-oxide-TMS protective layer 218 on the light-reflective layer 214. The sample light-reflective articles 200 are subjected to a xenon arc weatherometer apparatus manufactured by Envirotronics, Grand Rapids, Mich. (Model No. P83-15), per SAE J1960 but modified (type “S” borosilicate inner and outer filters, 0.55 watts per square meter (W/m²) radiant exposure). The test calls for exposure for 3,000 hours (125 days). Meeting the required performance criteria (i.e., passing the test) requires that the coating system 204 show no color change in excess of the specified Gray Scale rating (AATCC Evaluation Procedure 1/ISO 105-A02, the entirety of which is incorporated by reference herein), and exhibit no cracking, crazing or other deterioration. Applicants believe that light-reflective articles 200 will meet these performance standards, although this Example 5 has not yet been carried out.

### Example 6

Light-reflective articles 200 fabricated in accordance with the implementation described above and illustrated in FIG. 2 may be subjected to a resistance to scratching test per Ford Motor Company's performance specification WSS-M98P13-A, Aug. 15, 2006, Section 3.7.3. Each light-reflective article 200 to be tested may be a first surface chrome (FSC) mirror including a polycarbonate polymeric substrate 202, an acrylate—containing polymeric coating layer 250 applied to the polymeric substrate 202, and a light-reflective coating system 204 applied to the acrylate—containing polymeric coating layer 250. The light-reflective coating system 204 may include a chromium tie layer 206 adhered to the acrylate—containing polymeric coating layer 250, a DLC support layer 210 on the tie layer 206, a chromium light-reflective layer 214 on the DLC support layer 210, and a DLC-containing TMS-oxide-TMS protective layer 218 on the light-reflective layer 214. Meeting the required performance criteria (i.e., passing the test) requires that the coating system 204 show a visual rating of no more than 2 at a 2-N force applied by a 1.0±0.1 millimeter steel ball. The sample light-reflective articles 200 are subjected to scratch testing per the procedure specified by protocol FLTM BN108-13, the entirety of which is incorporated by reference herein. This scratch test includes subjecting the sample light-reflective articles 200 to the protocol utilizing a mechanically-driven scratch unit manufactured by Gardner (Model No. AV1653). Meeting the required performance criteria further requires that the sample light-reflective articles 200 display no damage to the reflective surface at the required 2-N force applied by the designated steel ball. Applicants believe that light-reflective articles 200 will meet these performance standards, although this Example 6 has not yet been carried out.

### Example 7

Light-reflective articles 200 fabricated in accordance with the implementation described above and illustrated in FIG. 2 may be subjected to a thermal shock test per Freightliner Standard 49-0085 (Feb. 25, 2003 Section 7.2), which is a variation of Ford Motor Company's performance specification WSS-M80J6-A, Sep. 12, 2005, Section 3.7.3. Each light-reflective article 200 to be tested may be a first surface chrome (FSC) mirror including a polycarbonate polymeric substrate 202, an acrylate—containing polymeric coating layer 250 applied to the polymeric substrate 202, and a light-reflective coating system 204 applied to the acrylate—containing polymeric coating layer 250. The light-reflective coating system 204 may include a chromium tie layer 206 adhered to the acrylate—containing polymeric coating layer 250, a DLC support layer 210 on the tie layer 206, a chromium light-reflective layer 214 on the DLC support layer 210, and a DLC-containing TMS-oxide-TMS protective layer 218 on the light-reflective layer 214. Meeting the required performance criteria (i.e., passing the test) requires that the coating system 204 after thermal shock cycling shows no blistering or uneven appearance or other detrimental effects. The sample light-reflective articles 200 must not display distortion, and there must be no loss of adhesion, cracking, visual loss of reflectivity, or reduced distinctiveness of image (DOI) when compared to a master sample light-reflective article 200. There should also be no loss of adhesion of the reflective surface to the underlying polymeric substrate 202. The sample light-reflective articles 200 are placed in a thermal shock chamber manufactured by Envirotronics, Grand Rapids, Mich. (Model No. SV3-2-2-10). The sample light-reflective articles 200 are exposed to thirty-six (36) cycles for a total exposure of six (6) consecutive days. Each 4-hour cycle includes the following conditioning intervals within the thermal shock chamber and a cold box, with transfers being made in one (1) minute or less: two hours at −40° C., followed by two hours at 78° C. Meeting the required performance criteria further requires that no abnormalities be noted, and that the exposed light-reflective articles 200 display no loss of reflectivity or reduced distinctiveness of image (DOI) when compared to the master sample light-reflective article 200. Applicants believe that light-reflective articles 200 will meet these performance standards, although this Example 7 has not yet been carried out.

### Example 8

Light-reflective articles 200 fabricated in accordance with the implementation described above and illustrated in FIG. 2 may be subjected to a salt spray test per ASTM B 117-03. Each light-reflective article 200 to be tested may be a first surface chrome (FSC) mirror including a polycarbonate polymeric substrate 202, an acrylate—containing polymeric coating layer 250 applied to the polymeric substrate 202, and a light-reflective coating system 204 applied to the acrylate—containing polymeric coating layer 250. The light-reflective coating system 204 may include a chromium tie layer 206 adhered to the acrylate—containing polymeric coating layer 250, a DLC support layer 210 on the tie layer 206, a chromium light-reflective layer 214 on the DLC support layer 210, and a DLC-containing TMS-oxide-TMS protective layer 218 on the light-reflective layer 214. Meeting the required performance criteria (i.e., passing the test) requires the coating system 204 after exposure to salt spray for 1,000 hours to display no discoloration, visible areas of corrosion, and visible reduction in reflectivity; and to exhibit no loss of adhesion. The sample light-reflective articles 200 are placed in a salt spray chamber and exposed to a 5% salt solution at 95° F. for 1,008 hours (42 days). Meeting the required performance criteria further requires that the exposed light-reflective articles 200 display no evidence of discoloration, loss of adhesion, visible areas of corrosion, or visible reduction in reflectivity. Applicants believe that light-reflective articles 200 will meet these performance standards, although this Example 8 has not yet been carried out.

### Example 9

Light-reflective articles 200 fabricated in accordance with the implementation described above and illustrated in FIG. 2 may be subjected to a solvent resistance test per FLTM BI 168-01. Each light-reflective article 200 to be tested may be a first surface chrome (FSC) mirror including a polycarbonate polymeric substrate 202, an acrylate—containing polymeric coating layer 250 applied to the polymeric substrate 202, and a light-reflective coating system 204 applied to the acrylate—containing polymeric coating layer 250. The light-reflective coating system 204 may include a chromium tie layer 206 adhered to the acrylate—containing polymeric coating layer 250, a DLC support layer 210 on the tie layer 206, a chromium light-reflective layer 214 on the DLC support layer 210, and a DLC-containing TMS-oxide-TMS protective layer 218 on the light-reflective layer 214. Meeting the required performance criteria (i.e., passing the test) requires that the coating system 204 after splashed with a given solvent for fifteen (15) minutes at 70° F. or 120° F. displays no change in physical appearance, and no marring or softening. The sample light-reflective articles 200 are cut into sections and each section has the cut edges taped with masking tape. The sample light-reflective articles 200 are then positioned at approximately a 15-degree angle from the vertical. One sample light-reflective article 200 per chemical is tested. A one milliliter (ml) pipette is employed to splash a given solvent on the top face of a given sample light-reflective article 200 and the solvent is allowed to run down the surface. After 15 minutes a visual examination is done, and any chemical left on the surface is removed using a clean cotton cloth. The surface is also checked for marring or softening. TABLE 5 below summarizes the tests to be performed.

TABLE 5

| | Method of | | |
|---|---|---|---|
| Chemicals | Exposure | Duration | Temperatures |
| Alcohols: | | | |
| Methanol (Reagent grade) | Splash | 15 min | 70° F. |
| Isopropyl Alcohol | Splash | 15 min | 70° F. |
| (Reagent grade) | | | |
| Esters: | | | |
| Ethyl acetate | Splash | 15 min | 70° F. |
| (Denatured alcohol) | | | |
| Ketones: | | | |
| Acetone (Reagent grade) | Splash | 15 min | 70° F. |
| Methylethylketone (MEK) | Splash | 15 min | 70° F. |
| Reagent grade | | | |
| Hydrocarbons: | | | |
| Toluene (Reagent grade) | Splash | 15 min | 70° F. |
| Xylene | Splash | 15mm. | 70° F. |
| Naphtha | Splash | 15 min | 70° F. |
| (Safety-Kleen Premium solvent) | | | |
| Citrus Based Cleaners: | | | |
| D-Limonene | Splash | 15mm. | 70° F. |
| Ammonia: | | | |
| Windex | Splash | 15 min | 70° F. |
| Acids: | | | |
| Sodium Hydroxide (pH 13) | Splash | 15 min | 70° F. |
| Hydrofluoric Acid (pH <1.0) | Splash | 15 min | 70° F. |
| Sulfuric Acid (pH 2.5) | Splash | 15 min | 70° F. |
| Sulfuric Acid (35% Battery acid) | Splash | 15 min | 70° F. |

Applicants believe that light-reflective articles 200 will meet these performance standards as to all solvents applied, although this Example 9 has not yet been carried out.

### Example 10

Light-reflective articles 200 fabricated in accordance with the implementation described above and illustrated in FIG. 2 may be tested for reflectivity, transmittance, distortion, and radius of curvature, per Ford Motor Company's performance specification WSB-M26G8-E (including but not limited to sections 3.2, 3.5, 3.6.2, 3.7, 3.8.2 and 3.12), the entirety of which is incorporated herein by reference. Each light-reflective article 200 to be tested may be a first surface chrome (FSC) mirror including a polycarbonate polymeric substrate 202, an acrylate—containing polymeric coating layer 250 applied to the polymeric substrate 202, and a light-reflective coating system 204 applied to the acrylate—containing polymeric coating layer 250. The light-reflective coating system 204 may include a chromium tie layer 206 adhered to the acrylate—containing polymeric coating layer 250, a DLC support layer 210 on the tie layer 206, a chromium light-reflective layer 214 on the DLC support layer 210, and a DLC-containing TMS-oxide-TMS protective layer 218 on the light-reflective layer 214. All test values in this example are based on materials conditioned in a controlled atmosphere of 23° C.±2° C. and 50%±5% relative humidity for 24 hours. Meeting the required performance criteria (i.e., passing the test) requires: that the coated surface of a sample light-reflective article 200 remains free from noticeable defects in accordance with section 3.5; that a sample light-reflective article 200 have a minimum reflectivity of 50% per SAE J964 section 3.6.2; that luminous transmittance (standard illuminant A, International Commission on Illumination (CIE)) of a sample light-reflective article 200 not exceed 4% measured at normal incident to the surface in accordance with section 3.7; that a sample light-reflective article 200 not exhibit any waviness as defined in section 3.8.2; and that the radius of curvature of a sample light-reflective article 200 remains within design specification tolerances as specified in section 3.12. Applicants believe that light-reflective articles 200 will meet these performance standards, although this Example 10 has not yet been carried out.

### Example 11

Light-reflective articles 200 fabricated in accordance with the implementation described above and illustrated in FIG. 2 may be subjected to an abrasion resistance test per Ford Motor Company's performance specification WSS-M80J6-A, Sep. 12, 2005, Section 3.7.1. Each light-reflective article 200 to be tested may be a first surface chrome (FSC) mirror including a polycarbonate polymeric substrate 202, an acrylate—containing polymeric coating layer 250 applied to the polymeric substrate 202, and a light-reflective coating system 204 applied to the acrylate—containing polymeric coating layer 250. The light-reflective coating system 204 may include a chromium tie layer 206 adhered to the acrylate—containing polymeric coating layer 250, a DLC support layer 210 on the tie layer 206, a chromium light-reflective layer 214 on the DLC support layer 210, and a DLC-containing TMS-oxide-TMS protective layer 218 on the light-reflective layer 214. Meeting the required performance criteria (i.e., passing the test) requires that the coating system 204 after abrasion testing exhibit no more than a 7% increase in haze. The testing protocol calls for the sample light-reflective articles 200 to each be subjected to 300 abrasion cycles as defined in FLTM BN 108-02 using a Taber Abrader, a CS-10 wheel, and a 500 gram load. Meeting the required performance criteria further requires that the exposed light-reflective articles 200 display less than a 7% increase in haze when compared to a master sample light-reflective article 200. Applicants believe that light-reflective articles 200 will meet these performance standards, although this Example 11 has not yet been carried out.

### Example 12

Light-reflective articles 200 fabricated in accordance with the implementation described above and illustrated in FIG. 2 may be subjected to adhesion testing in accordance with General Motors Engineering Standard GM4372M, June 1992, sections 3.4 and 3.5, the entirety of which is incorporated herein by reference. Each light-reflective article 200 to be tested may include a polycarbonate/ABS polymeric substrate 202 formed as a bezel, a type of rim typically utilized in instrument clusters provided in automotive vehicles, the light-reflective article 200 further having an acrylate—containing polymeric coating layer 250 applied to the polymeric substrate 202, and a light-reflective coating system 204 applied to the polymeric coating layer 250. The light-reflective coating system 204 may include a chromium tie layer 206 adhered to the polymeric coating layer 250, a DLC support layer 210 on the tie layer 206, a chromium light-reflective layer 214 on the DLC support layer 210, and a DLC-containing TMS-metal oxide-TMS protective layer 218 on the light-reflective layer 214. Meeting the required performance criteria for adhesion (i.e., passing the adhesion test) requires that the sample light-reflective articles 200 be subjected to Saw Grind Test defined in ASTM B571, then subjected to 22 hours of CASS corrosion exposure as specified in ASTM B368, and then subjected to four thermal cycles, each cycle including: 1 hour at −30° C., 15 minutes at room temperature, 1 hour at 85° C., and then 15 minutes at room temperature. Meeting the required performance criteria for adhesion (i.e., passing the adhesion test) requires that the coating system 204 exhibit no evidence of lifting or peeling between layers of the sample light-reflective articles 200. Applicants believe that light-reflective articles 200 will meet these performance standards, although this Example 12 has not yet been carried out.

### Example 13

Light-reflective articles 200 fabricated in accordance with the implementation described above and illustrated in FIG. 2 may be subjected to grind saw, thermal shock, chip resistance, thermal cycle, and environmental cycle testing in accordance with Ford Engineering Standard WSB-M1P83-C2, the entirety of which is incorporated herein by reference. Each light-reflective article 200 to be tested may include a polycarbonate/ABS polymeric substrate 202 formed as a bezel, a type of rim typically utilized in instrument clusters provided in automotive vehicles, the light-reflective article 200 further having an acrylate—containing polymeric coating layer 250 applied to the polymeric substrate 202, and a light-reflective coating system 204 applied to the polymeric coating layer 250. The light-reflective coating system 204 may include a chromium tie layer 206 adhered to the polymeric coating layer 250, a DLC support layer 210 on the tie layer 206, a chromium light-reflective layer 214 on the DLC support layer 210, and a DLC-containing TMS-metal oxide-TMS protective layer 218 on the light-reflective layer 214. Meeting the required performance criteria (i.e., passing the tests) requires that the sample light-reflective articles 200 be subjected to the following protocols, the entireties of all of which are incorporated herein by reference: Saw Grind Test defined in ASTM B571; then subjected to Thermal Shock FLTM BI107-05; then subjected to Chip Resistance SAE J400; then subjected to five thermal cycles, each cycle including: 2 hours at 80° C., 1 hour at room temperature, 2 hours at −30° C., 1 hour at room temperature, and 16 hours of CASS corrosion exposure as specified in ASTM B368; and then three environmental cycles, each cycle including: 3 hours at 80° C., 1 hour at room temperature, 3 hours at −40° C., 1 hour at room temperature. Meeting the required performance criteria requires that the coating system 204 exhibit no evidence of lifting or peeling between layers of the sample light-reflective articles 200. Applicants believe that light-reflective articles 200 will meet these performance standards, although this Example 13 has not yet been carried out.

### Example 14

Light-reflective articles 200 fabricated in accordance with the implementation described above and illustrated in FIG. 2 may be subjected to testing in accordance with Nissan Engineering Standard NES M4063, the entirety of which is incorporated herein by reference. Each light-reflective article 200 to be tested may include a polycarbonate/ABS polymeric substrate 202 formed as a bezel, a type of rim typically utilized in instrument clusters provided in automotive vehicles, the light-reflective article 200 further having an acrylate—containing polymeric coating layer 250 applied to the polymeric substrate 202, and a light-reflective coating system 204 applied to the polymeric coating layer 250. The light-reflective coating system 204 may include a chromium tie layer 206 adhered to the polymeric coating layer 250, a DLC support layer 210 on the tie layer 206, a chromium light-reflective layer 214 on the DLC support layer 210, and a DLC-containing TMS-metal oxide-TMS protective layer 218 on the light-reflective layer 214. Meeting the required performance criteria (i.e., passing the test) requires that the sample light-reflective articles 200 be subjected to 80 hours of CASS corrosion exposure as specified in ASTM B368, and then subjected to four thermal cycles, each cycle including: 4 hours at 80° C., 30 minutes at room temperature, 1.5 hours at −40° C., 30 minutes at room temperature, 3 hours at 70° C. and 95% relative humidity, 30 minutes at room temperature, and 1.5 hours at −40° C. Meeting the required performance criteria requires that the coating system 204 exhibit no evidence of lifting or peeling between layers of the sample light-reflective articles 200. Applicants believe that light-reflective articles 200 will meet these performance standards, although this Example 14 has not yet been carried out.

### Example 15

Light-reflective articles 200 fabricated in accordance with the implementation described above and illustrated in FIG. 2 may be subjected to adhesion testing in accordance with Toyota Engineering Standard TSH 6504G, the entirety of which is incorporated herein by reference. Each light-reflective article 200 to be tested may include a polycarbonate/ABS polymeric substrate 202 formed as a bezel, a type of rim typically utilized in instrument clusters provided in automotive vehicles, the light-reflective article 200 further having an acrylate—containing polymeric coating layer 250 applied to the polymeric substrate 202, and a light-reflective coating system 204 applied to the polymeric coating layer 250. The light-reflective coating system 204 may include a chromium tie layer 206 adhered to the polymeric coating layer 250, a DLC support layer 210 on the tie layer 206, a chromium light-reflective layer 214 on the DLC support layer 210, and a DLC-containing TMS-metal oxide-TMS protective layer 218 on the light-reflective layer 214. Meeting the required performance criteria requires that the sample light-reflective articles 200 be subjected to 60 hours of CASS corrosion exposure as specified in ASTM B368; then be subjected to Chip Resistance Test TSH1553G, and then subjected to four thermal cycles, each cycle including: 1 hour at −30° C., 15 minutes at room temperature, 1 hour at 90° C., and then 15 minutes at room temperature. Meeting the required performance criteria requires that the coating system 204 exhibit no evidence of lifting or peeling between layers of the sample light-reflective articles 200. Applicants believe that light-reflective articles 200 will meet these performance standards, although this Example 15 has not yet been carried out.

### Example 16

Light-reflective articles 200 fabricated in accordance with the implementation described above and illustrated in FIG. 2 may be subjected to adhesion testing in accordance with DCX Engineering Standard PS-8810, the entirety of which is incorporated herein by reference. Each light-reflective article 200 to be tested may include a polycarbonate/ABS polymeric substrate 202 formed as a bezel, a type of rim typically utilized in instrument clusters provided in automotive vehicles, the light-reflective article 200 further having an acrylate—containing polymeric coating layer 250 applied to the polymeric substrate 202, and a light-reflective coating system 204 applied to the polymeric coating layer 250. The light-reflective coating system 204 may include a chromium tie layer 206 adhered to the polymeric coating layer 250, a DLC support layer 210 on the tie layer 206, a chromium light-reflective layer 214 on the DLC support layer 210, and a DLC-containing TMS-metal oxide-TMS protective layer 218 on the light-reflective layer 214. Meeting the required performance criteria requires that the sample light-reflective articles 200 be subjected to Saw Grind Test defined in ASTM B571, then subjected to three thermal cycles, each cycle including: 1 hour at 82° C., 1 hour at room temperature, 1 hour at −35° C., 1 hour at room temperature, and then 22 hours of CASS corrosion exposure as specified in ASTM B368. Meeting the required performance criteria requires that the coating system 204 exhibit no evidence of lifting or peeling between layers of the sample light-reflective articles 200. Applicants believe that light-reflective articles 200 will meet these performance standards, although this Example 16 has not yet been carried out.

### Example 17

Light-reflective articles 200 fabricated in accordance with the implementation described above and illustrated in FIG. 2 may be subjected to humidity and temperature resistance tests in accordance with General Motors Engineering Standard GM6119M, section 4, which references General Motors Engineering Standards GM4465P and GM9505P, the entireties of all of which are incorporated herein by reference. Each light-reflective article 200 to be tested may include a polycarbonate/ABS polymeric substrate 202 formed as a bezel, a type of rim typically utilized in instrument clusters provided in automotive vehicles, the light-reflective article 200 further having an acrylate—containing polymeric coating layer 250 applied to the polymeric substrate 202, and a light-reflective coating system 204 applied to the polymeric coating layer 250. The light-reflective coating system 204 may include a chromium tie layer 206 adhered to the polymeric coating layer 250, a DLC support layer 210 on the tie layer 206, a chromium light-reflective layer 214 on the DLC support layer 210, and a DLC-containing TMS-metal oxide-TMS protective layer 218 on the light-reflective layer 214. Meeting the required performance criteria as to both of the humidity and temperature resistance tests requires that the coating system 204 of the sample light-reflective articles 200 show no evidence of objectionable surface deterioration or color change following the designated exposures, including as examples, blooming, blistering, spotting, stress crackings, corrosion, loss of adhesion, or objectionable dimensional changes. The humidity test is carried out in accordance with GM4465P at a temperature of 38° C.±1° C. for 24 hours. The temperature resistance test is carried out in accordance with GM9505P, utilizing two iterations of cycle D in Table 4, each beginning with carrying out the humidity test, and then exposing the sample light-reflective articles 200 to: 4 hours at 85° C.±2° C., then 3 hours at room temperature, then 17 hours at 85° C.±2° C., then 168 hours at 70° C.±2° C., then 4 hours at −30° C.±2° C., and then 100 hours at 70° C.±2° C. Applicants believe that light-reflective article 200 will meet these performance standards, although this Example 17 has not yet been carried out.

It is understood that the teachings above with regard to the examples 100, 200 of light-reflective articles and of the method 300 each are mutually applicable to define suitable modifications of an example of a light-reflective article 100, 200 or of a method 300. Accordingly, the above teachings with regard to each of the examples 100, 200 of light-reflective articles and of the method 300 are deemed incorporated into the teachings above regarding each of the others among the examples 100, 200 of light-reflective articles and regarding the method 300.

The light-reflective articles disclosed in this specification of which the light-reflective articles 100, 200 are examples, may be utilized in a wide variety of applications. Such applications may include as examples, but are not limited to, mirrors for either indoor or outdoor use; mirrors utilized for automobiles, motorcycles, trucks, bicycles, other land vehicles, boats, ships, and aircraft; mirrors utilized as or forming a part of tools or instruments; optical products such as windshields, windows, and lenses for vision-corrective glasses, sunglasses, or scientific instruments; articles, decorations, ornamentations, outer plating or coatings for which a reflective, shiny or chrome-like appearance may be useful, such as automotive grills, instrument panels and bezels, insignia, interior trim, accent panels of portable devices including personal digital assistants, jewelry, apparel, accessories adorning apparel, architectural detailing, sales displays, and the like. The light-reflective articles 100, 200 may include complex shapes, detailing, light-reflective article surfaces conforming to surfaces of other articles, and other structural features taking advantage of the capability of forming the light-reflective articles 100, 200 to have a wide variety of dimensions, contours, and other selected structural specifications. Likewise, the method 300 may be utilized in fabricating an article 100, 200. While the foregoing description refers in some instances to the articles 100, 200, it is appreciated that the subject matter is not limited to these articles, or to the articles discussed in the specification. Articles having other configurations consistent with the foregoing teachings may be fabricated. Likewise, the method 300 may be utilized to fabricate any article having a polymeric substrate, a tie layer disposed on the polymeric substrate and having a composition including a metal element, a support layer including diamond-like carbon disposed on the tie layer, and a light-reflective layer disposed on the support layer and having a composition including a metal element; of which the articles 100, 200 are examples. Further, it is understood by those skilled in the art that the method 300 may include additional steps and modifications of the indicated steps.

The entirety of U.S. patent application Ser. No. 11/768,893, titled “Light-Reflective Articles and Methods for Making Them,” filed Jun. 26, 2007, assigned to the assignee of the present disclosure, is incorporated by reference herein.

It will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. A light-reflective article, comprising:
a polymeric substrate;
a tie layer disposed on the polymeric substrate and having a composition including a metal element;
a support layer including diamond-like carbon disposed on the tie layer; and
a light-reflective layer disposed on the support layer and having a composition including a metal element.

2. The light-reflective article of claim 1, further including a lubricious, optically-transparent protective layer disposed on the light-reflective layer, the protective layer including diamond-like carbon, silicon, and oxygen.

3. The light-reflective article of claim 2, wherein the protective layer has a friction coefficient of less than about 0.5.

4. The light-reflective article of claim 1, further including a polymeric coating layer disposed on the polymeric substrate, wherein the tie layer is disposed on the polymeric coating layer.

5. The light-reflective article of claim 1, wherein the composition of the tie layer further includes an element of the group consisting of chromium, titanium, aluminum, niobium, or a combination including two or more of the foregoing.

6. The light-reflective article of claim 1, wherein the composition of the tie layer further includes chromium.

7. The light-reflective article of claim 1, wherein the tie layer has a thickness of 10 Å or more.

8. The light-reflective article of claim 1, wherein the support layer has a thickness of 200 Å or more.

9. The light-reflective article of claim 1, wherein the thickness of the support layer is within a range of between about 200 Å and about 10,000 Å.

10. The light-reflective article of claim 1, wherein the support layer has a hardness of 5H or more as measured by a pencil hardness test according to ASTM D 3363-92a.

11. The light-reflective article of claim 1, wherein the support layer has a composition including 50% or more of atomic carbon, and atomic hydrogen within a range of between about 5% and about 30%.

12. The light-reflective article of claim 1, wherein the support layer includes a dopant element selected from the group consisting of nitrogen, silicon, boron, fluorine, titanium, tungsten, or a combination including two or more of the foregoing.

13. The light-reflective article of claim 1, wherein the support layer has a composition including 50% or more of atomic carbon, atomic hydrogen within a range of between about 5% and about 30%, and atomic silicon within a range of between about 2% and about 19%.

14. The light-reflective article of claim 1, wherein the diamond-like carbon of the support layer has an sp³ carbon-carbon atomic bond concentration of about 75% or more.

15. The light-reflective article of claim 1, wherein the diamond-like carbon of the support layer has an average density within a range of between about 2.1 gm/cm³ and about 3.5 gm/cm³.

16. The light-reflective article of claim 1, wherein the composition of the light-reflective layer includes an element selected from the group consisting of chromium, aluminum, silver, nickel, rhodium, gold, or a combination including two of more of the foregoing.

17. The light-reflective article of claim 1, wherein the composition of the light-reflective layer includes chromium.

18. The light-reflective article of claim 1, wherein the light-reflective layer has a thickness of about 300 Å or more.

19. The light-reflective article of claim 1, wherein the protective layer has a composition including atomic carbon within a range of between about 15% and about 90%, and atomic hydrogen within a range of between about 20% and about 75%.

20. The light-reflective article of claim 1, wherein the protective layer has a composition including atomic carbon within a range of between about 15% and about 90%, atomic hydrogen within a range of between about 20% and about 75%, atomic silicon within a range of between about 2% and about 19%, and atomic oxygen within a range of between about 2% and about 19%.

21. The light-reflective article of claim 4, wherein the polymeric coating layer includes an acrylate.

22. The light-reflective article of claim 4, wherein the polymeric coating layer includes a polysiloxane.

23. The light-reflective article of claim 1, wherein the article has a scratch resistance sufficient to give a rating of no more than 2 at 2N force with a 1.0±0.1 millimeter ball as measured according to the test method specified by FLTM BN108-13.

24. A method for fabricating a light-reflective article, the method comprising:
depositing a tie layer on a polymeric substrate, the deposited tie layer having a composition including a metal element;
depositing a support layer including diamond-like carbon on the tie layer; and
depositing a light-reflective layer on the support layer, the light-reflective layer including a metal element.

25. The method of claim 24 further including depositing a protective layer on the light-reflective layer, the deposited protective layer being lubricious and optically-transparent and including diamond-like carbon, silicon, and oxygen.

26. The method of claim 24 further including, prior to depositing the tie layer, depositing a polymeric coating layer on the polymeric substrate.

27. The method of claim 24, wherein the steps of depositing the tie layer, the support layer, and the light-reflective layer are performed in the same reaction chamber without breaking a vacuum between the steps.

28. The method of claim 24, wherein the deposited support layer has a thickness of 200 Å or more.

29. The method of claim 24, wherein the deposited support layer has a thickness within a range of between about 200 Å and about 10,000 Å.

30. The method of claim 24, wherein the deposited support layer has a hardness of 5H or more as measured by a pencil hardness test according to ASTM D 3363-92a.

31. The method of claim 24, wherein the support layer has a composition including 50% or more of atomic carbon, and atomic hydrogen within a range of between about 5% and about 30%.

32. The method of claim 24, wherein depositing the support layer includes depositing a dopant element selected from the group consisting of nitrogen, silicon, boron, fluorine, titanium, tungsten, or a combination including two or more of the foregoing.

33. The method of claim 24, wherein the support layer has a composition including 50% or more of atomic carbon, atomic hydrogen within a range of between about 5% and about 30%, and atomic silicon within a range of between about 2% and about 19%.

34. The method of claim 24, wherein the diamond-like carbon of the support layer has an sp³ carbon-carbon atomic bond concentration of about 75% or more.

35. The method of claim 24, wherein the diamond-like carbon of the support layer has an average density within a range of between about 2.1 gm/cm³ and about 3.5 gm/cm³.

36. The method of claim 24, wherein the composition of the light-reflective layer includes an element selected from the group consisting of chromium, aluminum, silver, nickel, rhodium, gold, or a combination including two or more of the foregoing.

37. The method of claim 24, wherein the composition of the light-reflective layer includes chromium.

38. The method of claim 24, wherein the protective layer has a composition including atomic carbon within a range of between about 15% and about 90%, and atomic hydrogen within a range of between about 20% and about 75%.

39. The method of claim 24, wherein the protective layer has a composition including atomic carbon within a range of between about 15% and about 90%, atomic hydrogen within a range of between about 20% and about 75%, atomic silicon within a range of between about 2% and about 19%, and atomic oxygen within a range of between about 2% and about 19%.

40. The method of claim 26, wherein the polymeric coating layer includes an acrylate.

41. The method of claim 26, wherein the polymeric coating layer includes a polysiloxane.
